(19) United States
(12) Patent Application Publication
(10) Pub. No.: US 2003/0078682 A1
(43) Pub. Date: Apr. 24, 2003

(54) Simulation apparatus and simulation method

(76) Inventors: Nobuhiko Tezuka, Tochigi (JP); Kunitaka Ozawa, Tochigi (JP)

Correspondence Address: FITZPATRICK CELLA HARPER & SCINTO, 30 ROCKEFELLER PLAZA, NEW YORK, NY, 10112, US

(21) Appl. No.: 10/268,751

(22) Filed: Oct. 11, 2002

(30) Foreign Application Priority Data
Oct. 19, 2001 (JP) 322581/2001

(51) Int. Cl. G05B 13/02

(52) U.S. Cl. 700/31

(57) ABSTRACT

A simulation apparatus 20A includes an operation terminal 21, display section 22, simulation section 23, and unit shape data 24. The simulation section 23 is synchronized with an actual exposure apparatus in real time, and executes three-dimensional simulation in accordance with the operation (control command) of each unit 13 to be controlled. A control command is sent from the apparatus controller 12 to the unit 13 and at the same time to the simulation section 23. Upon reception of the control command, the simulation section 23 operates the unit 13 in accordance with the instruction of the control command, and executes simulation.

### FIELD OF THE INVENTION

The present invention relates to a simulation apparatus and simulation method which are targeted to an apparatus for a semiconductor manufacturing process used to manufacture various devices including a semiconductor chip such as an IC or LSI, a display element such as a liquid crystal panel, a detection element such as a magnetic head, and an image sensing element such as a CCD.

### BACKGROUND OF THE INVENTION

An exposure apparatus for a semiconductor manufacturing process comprises, as units to be controlled for various driving operations, a reticle transfer apparatus which externally loads/unloads a reticle and transfers it to a predetermined location, a wafer transfer apparatus which externally loads/unloads a wafer and transfers it to a predetermined location, a reticle stage which supports and aligns a reticle in order to perform exposure to a circuit pattern, and a wafer stage which supports and aligns a wafer in order to expose it to a circuit pattern. These apparatuses are controlled by control software, and their positions and states change over time.

The exposure apparatus has a high-output exposure laser (e.g., an excimer laser) for performing exposure, and an interferometer laser for measuring the distance at high precision. These lasers are also controlled by control software.

Batch processing generally automates a series of processes such as reticle transfer, wafer transfer, alignment of associated units, and exposure. In measurement or driving or upon occurrence of an error, a safety mechanism operates to stop the apparatus. In recovery operation, driving of the stage, driving of the robot arm of the transfer system, and the like are executed in a manual operation mode, and any remaining wafer and the like are removed.

In the exposure apparatus, the stage and the robot arm of the transfer system transfer a wafer or reticle to each other, and must be carefully treated particularly in manual operation as units to be controlled which may cause physical interference. This is because physical interference damages these units, and damages or scatters a wafer or reticle, resulting in a serious failure.

In this case, an exact current position cannot be determined by control software, and physical interference occurs in subsequent operation at high possibility.

The operator generally obtains information by manipulating an operation terminal called a console via a user interface. The user interface holds, as a code, information about a unit which supports a wafer or reticle. The user interface maps the code into a significant graphical window to provide the information to the operator.

There is a simulation apparatus having a simulation program that represents each unit of the exposure apparatus. The simulation apparatus displays the operation position of each unit by graphic display or coordinate display as a result of virtually controlling the operation by simulations.

The internal state of the apparatus must be determined for trouble remedy, operation verification, debug, or recovery operation of the exposure apparatus.

For this purpose,

1) The apparatus cover is opened to check the interior. However, this method inevitably depends on subjective experience by visual check of the operator. The objectivity cannot be maintained in, e.g., specifying a defective portion.

2) The operation state of the apparatus or the like is visually displayed using a simulation apparatus. However, real-time analysis cannot be achieved in synchronism with simulation. A current operation state or the like cannot be determined, and monitoring and management are difficult to perform.

3) The operation state of the apparatus or the like is graphically displayed on a terminal. However, only states defined in advance can be displayed, little information is obtained, and the interior of the apparatus cannot be sufficiently determined.

Due to the three reasons, it is difficult to determine the internal state of the apparatus, decreasing the productivity.

### SUMMARY OF THE INVENTION

The present invention has been made to overcome the conventional drawbacks, and has as its object to provide a simulation apparatus and simulation method capable of easily determining the internal state of an apparatus and preventing physical interference and the like.

To overcome the conventional drawbacks and achieve the above object, according to the present invention, there is provided a simulation apparatus which executes simulation in synchronism with an actual apparatus, comprising a simulation unit which receives a control command that concerns each object to be controlled and is output in controlling the actual apparatus, and executes simulation on the basis of the control command, and a display unit which receives response information from the object with respect to the control command, and displays a simulation result of the object based on the response information.

According to the present invention, there is also provided a simulation method of executing simulation in synchronism with an actual apparatus, comprising the step of receiving a control command which concerns each object to be controlled and is output in controlling the actual apparatus, and executing simulation on the basis of the control command, and the step of receiving response information from the object with respect to the control command, and displaying a simulation result of the object based on the response information.

In the simulation apparatus and method, shape data of an actual apparatus is displayed on a computer screen, and a virtual reality space is created. The virtual reality space is created as a three-dimensional simulation model on the basis of shape data (e.g., three-dimensional CAD data, solid data, polygon data, or wire frame data) obtained when the exposure apparatus is designed by a three-dimensional CAD. Thus, the actual apparatus can be simulated in a virtual space on the computer screen. In other words, the positional relationship between units to be controlled in the actual apparatus and an assembly of them can be reproduced, and the degree of freedom of motion and the range of motion can be reproduced.

In the simulation means and step, a control command which concerns each object to be controlled and is output in controlling the actual apparatus is received, and simulation is executed on the basis of the control command.

The actual apparatus is constituted by control software which controls the whole apparatus, and units to be controlled that are formed from driving mechanisms. For an exposure apparatus, the units are a wafer stage, reticle stage, laser unit, wafer transfer apparatus, reticle transfer apparatus, and the like. The control software operates the driving mechanism of each unit by sending a control command to the unit.

In the display means and step, response information is received from the object with respect to the control command, and the simulation result of the object based on the response information is displayed.

The unit sends back its status as a unit status to the control software in operation.

In the simulation apparatus and method, the unit status is monitored by the display means, and its contents (apparatus state) are three-dimensionally displayed.

For example, if an error occurs, a unit suffering the error is displayed in different color on a graphic display.

It is preferable that the simulation apparatus and method be connected to the actual apparatus via a network and can be remote-controlled. The operation state of the actual apparatus can be determined even at a remote place via a virtual space.

Preferably, the simulation apparatus and method can be operated by multiple users.

By operating the simulation apparatus by multiple users, many people such as an operator, service man, and manager can simultaneously monitor the simulation apparatus.

In the detection unit and step, the relative positional relationship with another object to be controlled is preferably detected on the basis of control procedure information of the object during control of the object by the control command. More specifically, the relative positional relationship with another object to be controlled is detected when the operation stops during control of the object by the control command and the current position of the object becomes indefinite.

The current position becomes indefinite because the object may not necessarily reach the position designated by the control command if the operation stops owing to an error or the like.

Thus, in the detection unit and step, when the current position of the object is indefinite, an indefinite space where the object may exist is created from pre-stop position information and target position information of the object whose current position is indefinite and a control command to another object.

In the determination unit and step, whether the object interferes with another object to be controlled is determined from the indefinite space created by the detection means, and whether to continue the operation of the actual apparatus is determined.

When physical interference between objects to be controlled is checked using three-dimensional design data, another object which interferes with the indefinite space is checked.

When no interference is expected to occur upon determination by the determination unit and step, a control continuation command for making the object to keep driving is output in the simulation unit and step.

The present invention can also be applied to the form of a program which causes the computer of an external apparatus to execute any one of the above-described simulation methods, and the form of a computer-readable storage medium which stores the program.

As described above, according to the present invention, the internal state of the apparatus is expressed in real time by three-dimensional simulation. This allows safely determining what is going on inside the apparatus and easily managing and coping with a trouble.

A space where an object to be controlled at an indefinite position may exist is created, and physical interference is checked, thereby eliminating the possibility of generating physical interference in restart after the stop of operation. Recovery operation after the stop of operation can be safely performed, resulting in a long operating time of the apparatus and high productivity.

Other objects and advantages besides those discussed above shall be apparent to those skilled in the art from the description of a preferred embodiment of the invention which follows. In the description, reference is made to accompanying drawings, which form apart hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIG. 1 is a view showing the functional blocks of an exposure apparatus and simulation apparatus according to the first embodiment;

FIG. 2 is a view showing an arrangement in which an exposure apparatus and simulation apparatus are connected via a network according to the second embodiment;

FIG. 3 is a view showing an arrangement in which an exposure apparatus and simulation apparatus are connected via a network and can be operated by multiple users according to the third embodiment;

FIG. 4 is a view showing the functional blocks of an exposure apparatus and simulation apparatus according to the fourth embodiment;

FIG. 5 is a view showing the state transition between a normal mode and an error mode;

FIG. 6 is a block diagram showing data control of a command/status switching section;

FIG. 7 is a block diagram showing data control inside the simulation apparatus;

FIG. 8 is a view for explaining an indefinite space creation method;

FIG. 9 is a view for explaining another indefinite space creation method;

FIG. 10 is a view for explaining still another indefinite space creation method;

FIG. 11 is a flow chart showing the data control procedures of the command/status switching section; and

FIG. 12 is a flow chart showing data control procedures inside the simulation apparatus.

### DETAILED DESCRIPTION OF THE PREFERRED EMBODIMENTS

Preferred embodiments of the present invention will be described in detail below with reference to the accompanying drawings.

[First Embodiment]

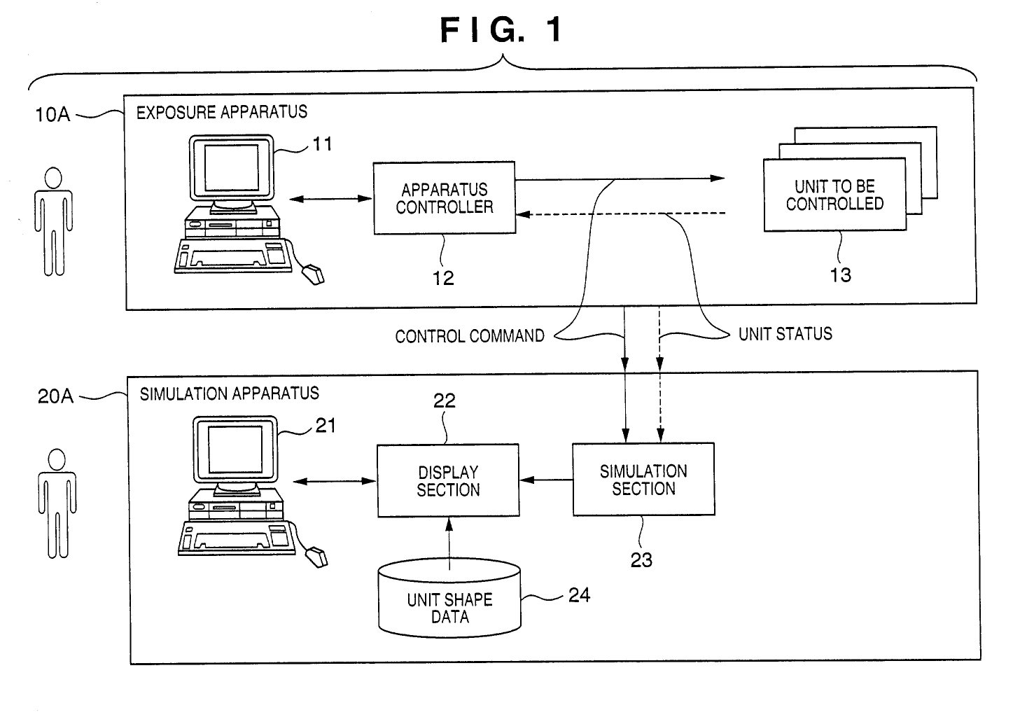

FIG. 1 shows the functional blocks of an exposure apparatus and simulation apparatus according to the first embodiment. An exposure apparatus 10A as an example of an apparatus for a semiconductor manufacturing process is constituted by an operation terminal 11, an apparatus controller 12, and units 13 to be controlled.

The operation terminal 11 serves as a man-machine interface, receives an operation from the operator, and graphically displays an apparatus state.

The apparatus controller 12 executes control of the whole apparatus. The apparatus controller 12 interprets a command input from the operation terminal 11, and distributes control commands to the units 13 while scheduling the entire apparatus. The apparatus controller 12 receives responses from the units 13 as unit statuses.

The units 13 include a wafer stage, reticle stage, laser unit, wafer transfer apparatus, and reticle transfer apparatus. Upon reception of control commands, the units 13 control hardware (e.g., stage driving) under their control.

A simulation apparatus 20A comprises an operation terminal 21, display section 22, simulation section 23, and unit shape data 24.

The operation terminal 21 has an image processing function of expressing a three-dimensional graphic image.

The display section 22 converts three-dimensional shape data of the exposure apparatus 10A into a three-dimensional graphic image, and displays the driving state of each unit 13 as a simulation result. That is, the display section 22 reproduces the positional relationship between actual units 13 and an assembly of them, and reproduces the degree of freedom of motion and the range of motion.

The simulation section 23 is synchronized with an actual exposure apparatus in real time, and executes three-dimensional simulation in accordance with the operation (control command) of each unit 13.

The unit shape data 24 includes three-dimensional CAD data, solid data, polygon data, and wire frame data. These data can create a virtual reality space by using three-dimensional CAD data generated in design of the exposure apparatus.

A control command is sent from the apparatus controller 12 to the unit 13 and at the same time to the simulation section 23. Upon reception of the control command, the simulation section 23 operates the unit 13 in accordance with the instruction of the control command, and executes simulation. When the unit 13 is a wafer stage and the control command is a designated-position driving control command, the simulation section 23 receives the coordinates of a designated position.

In normal driving free from any error, the simulation section 23 receives a normal termination signal as a unit status from the unit 13. In this case, the three-dimensional image of the wafer stage is rewritten every sampling time in consideration of the driving speed and driving acceleration, and the image is settled at the coordinates of the designated position.

Upon occurrence of an error, the simulation section 23 receives an abnormal termination signal as a unit status from the unit 13. Upon occurrence of an error, the three-dimensional display portion of the unit exhibiting the error is changed in color to notify the operator of the error.

In this way, the operator can see as a three-dimensional image the operation of each portion of the apparatus, which is normally hidden and cannot be seen.

The exposure apparatus 10A and simulation apparatus 20A can be assembled into any apparatus, or can be separate structures.

[Second Embodiment]

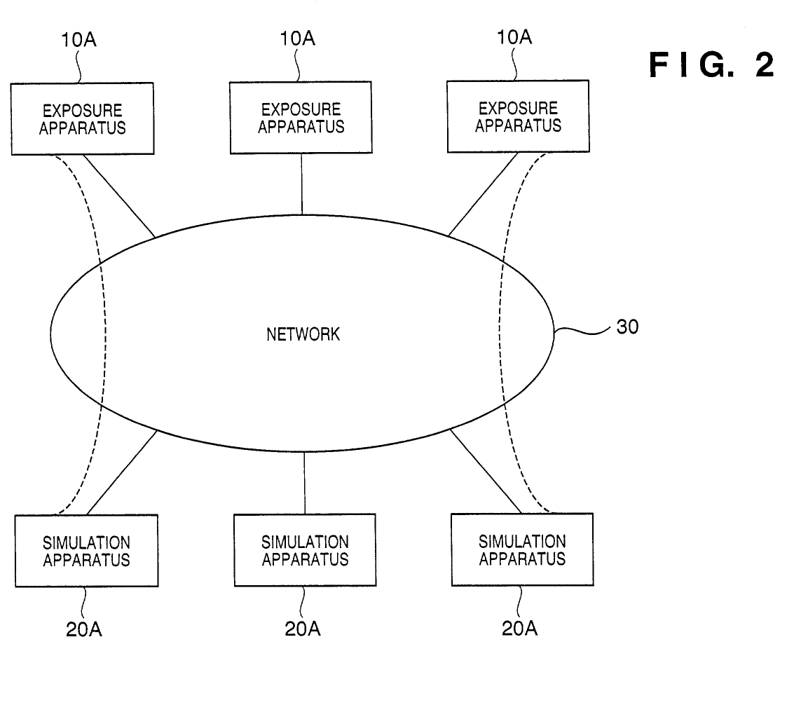

FIG. 2 shows the second embodiment in which a remote-controllable network is constructed by communicably connecting exposure apparatuses 10A and simulation apparatuses 20A via a network 30. Even if the exposure apparatus 10A is installed in a clean room, the simulation apparatus 20A can be installed in an office or the like.

[Third Embodiment]

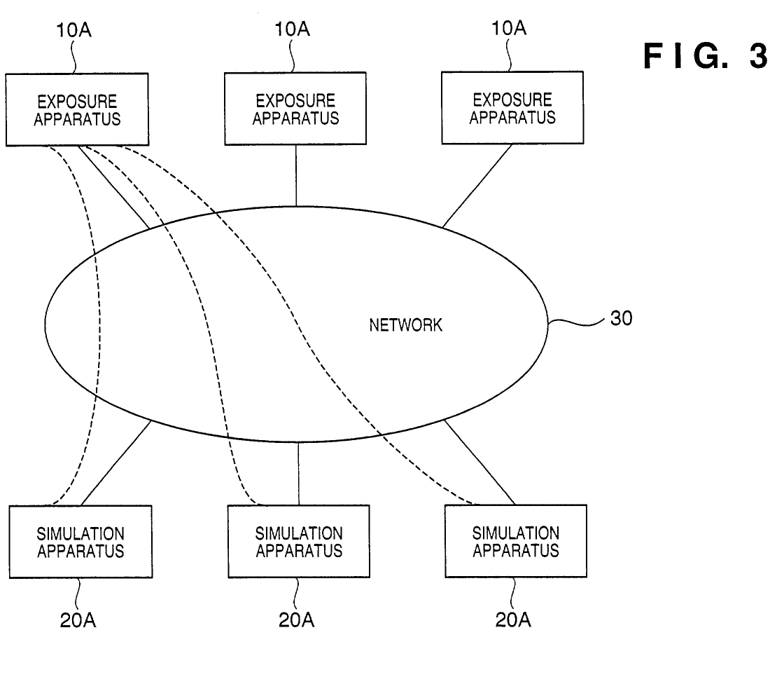

FIG. 3 shows the third embodiment in which exposure apparatuses 10A and simulation apparatuses 20A are communicably connected via a network, and each apparatus can be operated by multiple users. Even if a given exposure apparatus is installed in a clean room, a simulation apparatus can be installed in the office of each authority, and the authority can simultaneously monitor the exposure apparatus and simulation apparatus, as needed. The apparatuses can be easily managed not only by the operator but also by the manager.

[Fourth Embodiment]

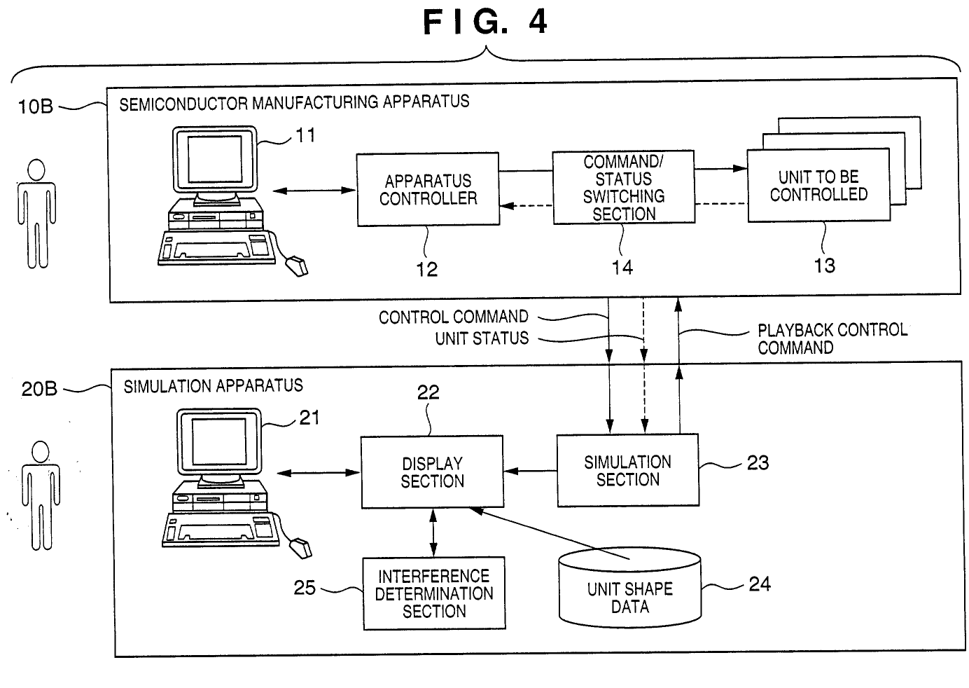

FIG. 4 shows the functional blocks of an exposure apparatus and simulation apparatus according to the fourth embodiment. The same reference numerals denote blocks having the same functions as those in FIG. 1, and a detailed description thereof will be omitted.

As shown in FIG. 4, an exposure apparatus 10B comprises a command/status switching section 14 in addition to an operation terminal 11, an apparatus controller 12, and units 13 to be controlled shown in FIG. 1.

The command/status switching section 14 is interposed between the apparatus controller 12 and the units 13. The command/status switching section 14 switches between a state in which a control command is sent from the apparatus controller 12 to the unit 13 and a state in which a unit status is sent back from the unit 13 to the apparatus controller 12 upon reception of the control command.

A simulation apparatus 20B comprises an interference determination section 25 in addition to an operation terminal 21, a display section 22, a simulation section 23, and a unit shape data 24 shown in FIG. 1.

The interference determination section 25 determines whether physical interference may occur due to the relative positional relationship between the units 13.

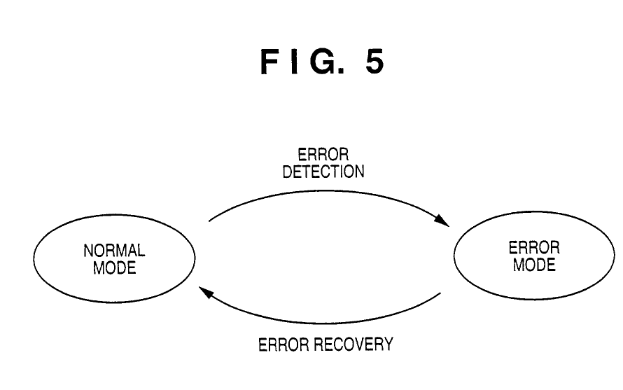

FIG. 5 shows the mode state transition between a normal mode and an error mode. The mode is switched between the two states in response to an error detection event and error recovery event. The command flow changes depending on the mode.

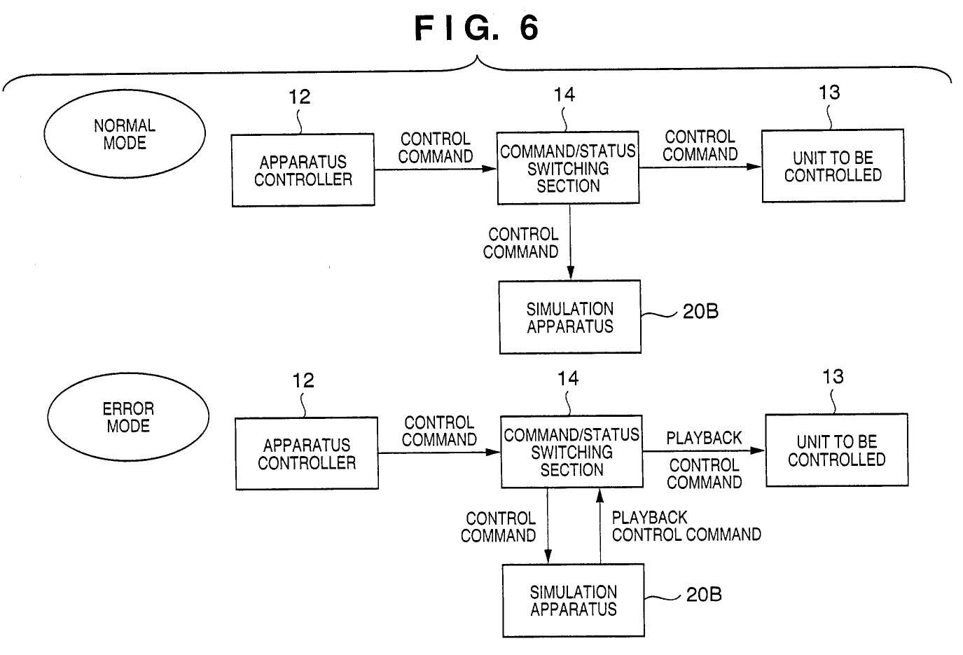

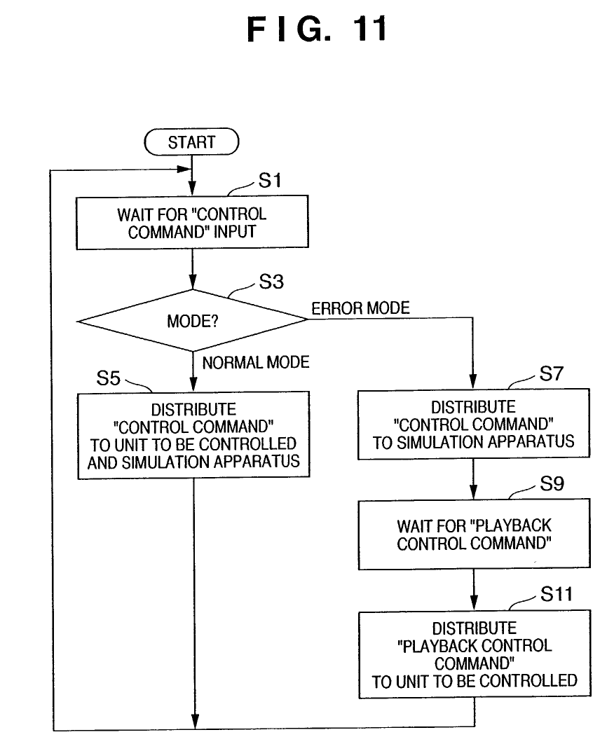

FIG. 6 shows data control of the command/status switching section 14, and FIG. 11 is a flow chart showing data control procedures in FIG. 6.

In FIGS. 6 and 11, if the mode is the normal mode in step S3 after a control command input wait state in step S1, the command/status switching section 14 distributes a control command transmitted from the apparatus controller 12 to the unit 13 and simulation apparatus 20B in step S5.

If the mode is the error mode in step S3, the command/status switching section 14 first distributes a control command transmitted from the apparatus controller 12 to the simulation apparatus 20B (step S7). The simulation apparatus 20B sends back a playback control command to the command/status switching section 14 only when the interference determination section 25 determines no interference.

If the command/status switching section 14 receives the playback control command in the playback control command input wait state in step S9, the section 14 distributes the playback control command to the unit 13 (step S11).

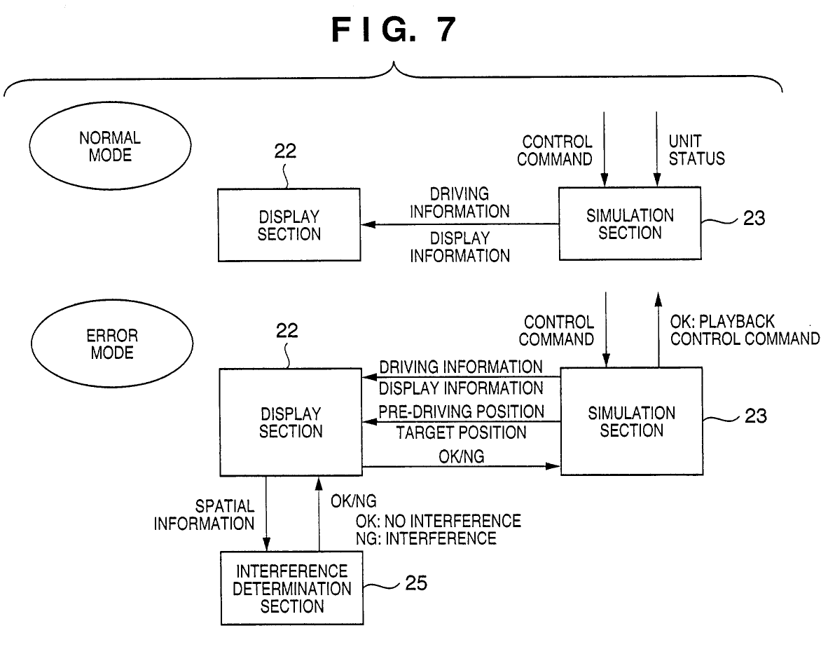

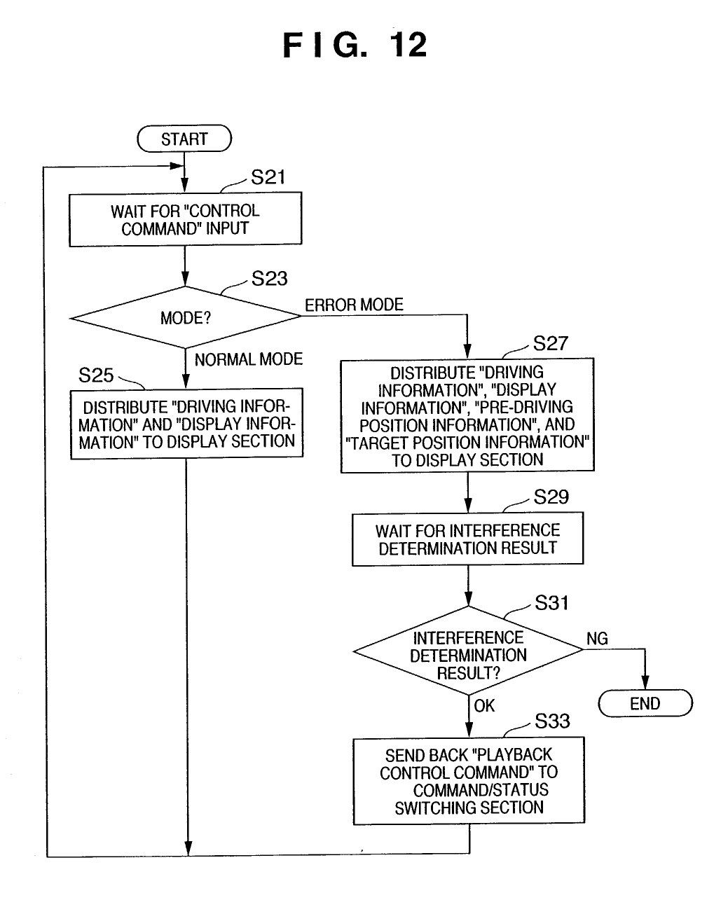

FIG. 7 shows data control inside the simulation apparatus, and FIG. 12 is a flow chart showing data control procedures in FIG. 7.

In FIGS. 7 and 12, if the mode is the normal mode in step S23 after a control command input wait state in step S21, the simulation section 23 which has received a control command executes simulation, and distributes the results as driving information and display information to the display section 22.

The display section 22 displays the three-dimensional image of the unit 13 as a driving result on the basis of the information received from the simulation section 23.

A unit status is received by the simulation section 23 and then distributed as display information to the display section 22.

If the mode is the error mode in step S23, a control command received by the simulation section 23 is distributed to the display section 22 as driving information and display information of an object to be controlled (step S27). As for an object to be controlled which exists at an indefinite position owing to an error, pre-driving position information is distributed to the display section 22 together with target position information.

The display section 22 creates an indefinite position space on the basis of the pre-driving position information, the target position information, and environmental information of another object to be controlled.

The interference determination section 25 determines the presence of physical interference on the basis of the indefinite position space and three-dimensional information of another object to be controlled. The interference determination section 25 sends the determination result to the display section 22.

The simulation section 23 which has received the interference determination result in an interference determination result wait state in step S29 sends back a playback control command to the command/status switching section 14 only when a result representing that no interference occurs is obtained as the interference determination result in step S31 (step S33). Upon reception of the playback control command, the command/status switching section 14 distributes it to the unit 13.

If a result representing that interference has occurred is obtained as the interference determination result in step S31, this data control ends.

[Fifth Embodiment]

In the fourth embodiment, the display section 22 creates an indefinite position space. A method of predicting a position (indefinite space) where an object to be driven may be present changes depending on the property and conditions of an object to be controlled. The prediction method adopts the following three patterns:

\hat{1} A space obtained by interpolating, as a three-dimensional space, the interval between a position where the object was before driving and a target position.

\hat{2} A space obtained by interpolating, as a three-dimensional space, the interval between a position where the object was before driving and a target position and the interval between the target position and a limit position on the extended line.

\hat{3} All three-dimensional spaces considering the degree of freedom of driving.

\hat{1} to \hat{3} will be explained in detail.

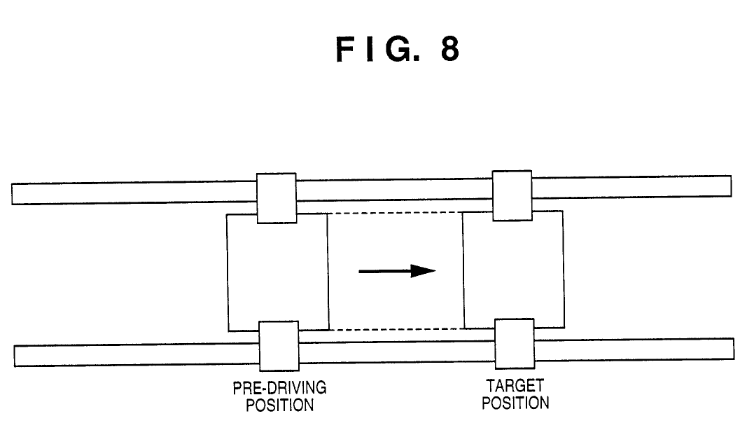

\hat{1} In a driving system which stops at a target position, the indefinite space is predicted by the method of interpolating, as a three-dimensional space, the interval between a position where the driving system was before driving and a target position (see FIG. 8).

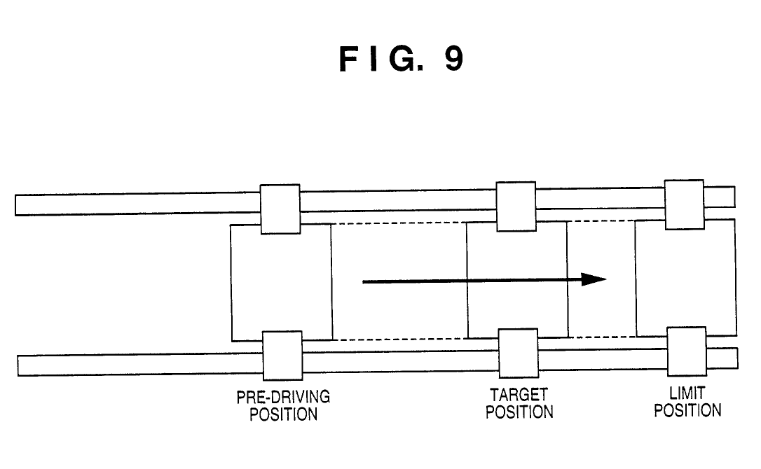

\hat{2} In a driving system which is given a target position but does not stop at this position owing to the inertia, the interval between a position where the driving system was before driving and a target position and the interval between the target position and a limit position on the extended line are predicted as an indefinite space (see FIG. 9).

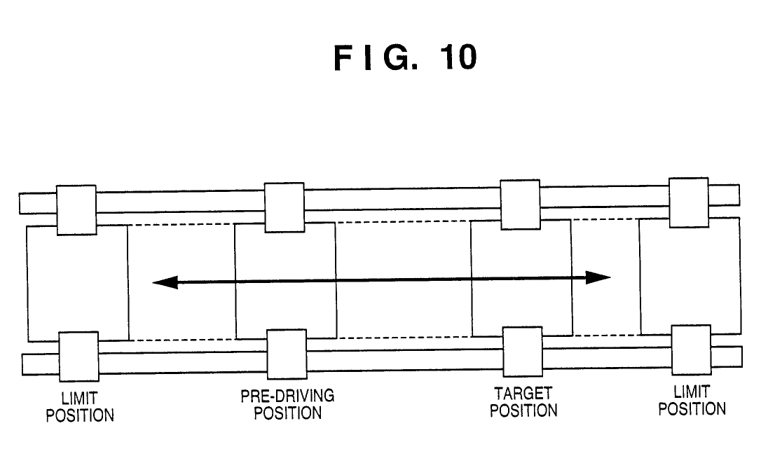

\hat{3} When driving cannot be restricted by a driving instruction, all three-dimensional spaces are predicted as indefinite spaces in consideration of the degree of freedom of driving of the driving system. For example, for a driving system drivable on the X-Y plane, spaces where the driving system may be present under limit conditions added to the X-Y plane are indefinite spaces (see FIG. 10).

[Other Embodiment]

The embodiments have been described in detail above. The present invention may be applied to a system constituted by a plurality of devices or an apparatus formed from a single device.

The present invention is also achieved when a software program (including programs corresponding to the flow charts shown in FIGS. 11 and 12 in the embodiments) which realizes the functions of the above-described embodiments is supplied to a system or apparatus directly or from a remote place, and the system or apparatus reads out and executes the supplied program codes. In this case, the present invention need not take the form of a program as far as a program function is provided.

Hence, the present invention is also realized by program codes installed in a computer in order to realize functional processing of the present invention by the computer. The claims of the present invention include a computer program for realizing functional processing of the present invention.

In this case, the program can adopt any form such as an object code, a program executed by an interpreter, or script data supplied to the OS as far as a program function is provided.

Recording media for supplying the program are a floppy disk, hard disk, optical disk, magnetooptical disk, MO, CD-ROM, CD-R, CD-RW, magnetic tape, nonvolatile memory card, ROM, DVD (DVD-ROM or DRD-R), and the like.

The program can also be supplied by accessing a home page on the Internet using the browser of a client computer, and downloading the computer program of the present invention or a compressed file containing an automatic install function from the home page to a recording medium such as a hard disk. The present invention can also be realized by dividing program codes which constitute the program of the present invention into a plurality of files and downloading these files from different home pages. That is, the claims of the present invention also include a WWW server which causes a plurality of users to download program files for realizing functional processing of the present invention by a computer.

The present invention can also be realized as follows. The program of the present invention is encrypted, stored in a storage medium such as a CD-ROM, and distributed to the user. A user who has cleared predetermined conditions is allowed to download key information for decrypting the program from a home page via the Internet. The user executes the encrypted program by using the key information, and installs the program in a computer.

The functions of the above-described embodiments are realized when the computer executes a readout program. Also, the functions of the above-described embodiments are realized when an OS running on the computer performs part or all of actual processing on the basis of the instructions of the program.

The functions of the above-described embodiments are also realized when the program read out from the recording medium is written in the memory of a function expansion board inserted into the computer or the memory of a function expansion unit connected to the computer, and the CPU of the function expansion board or function expansion unit performs part or all of actual processing on the basis of the instructions of the program.

The present invention is not limited to the above embodiments and various changes and modifications can be made within the spirit and scope of the present invention. Therefore, to appraise the public of the scope of the present invention, the following claims are made.

What is claimed is:

1. A simulation apparatus which executes simulation in synchronism with an actual apparatus, comprising:
a simulation unit which receives a control command that concerns each object to be controlled and is output in controlling the actual apparatus, and executes simulation on the basis of the control command; and
a display unit which receives response information from the object with respect to the control command, and displays a simulation result of the object based on the response information.

2. The apparatus according to claim 1, wherein said simulation unit executes three-dimensional simulation synchronized with the actual apparatus in real time.

3. The apparatus according to claim 1, wherein the simulation apparatus is connected to the actual apparatus via a network and can be remote-controlled.

4. The apparatus according to claim 1, wherein the simulation apparatus is connected to the actual apparatus via a network, can be remote-controlled, and is operated by multiple users together with the actual apparatus.

5. The apparatus according to claim 1, wherein the actual apparatus includes an apparatus used in a semiconductor manufacturing process.

6. The apparatus according to claim 1, further comprising a detection unit which detects a relative positional relationship with another object to be controlled on the basis of control procedure information of the object during control of the object by the control command.

7. The apparatus according to claim 1, further comprising a detection unit which detects a relative positional relationship with another object to be controlled when operation stops during control of the object by the control command and a current position of the object becomes indefinite.

8. The apparatus according to claim 7, wherein, when a current position of the object is indefinite, said detection unit creates an indefinite space where the object may exist, from pre-stop position information and target position information of the object whose current position is indefinite and a control command to another object.

9. The apparatus according to claim 8, further comprising a determination unit which determines from the indefinite space created by said detection unit whether the object interferes with another object to be controlled, and determines whether to continue operation of the actual apparatus.

10. The apparatus according to claim 9, wherein, when no interference occurs as a determination result of said determination unit, said simulation unit outputs a control continuation command for making the object to keep driving.

11. A simulation method of executing simulation in synchronism with an actual apparatus, comprising the steps of:
receiving a control command which concerns each object to be controlled and is output in controlling the actual apparatus, and executing simulation on the basis of the control command; and
receiving response information from the object with respect to the control command, and displaying a simulation result of the object based on the response information.

12. The method according to claim 11, wherein the simulation includes three-dimensional simulation synchronized with the actual apparatus in real time.

13. The method according to claim 11, wherein the simulation can be executed from a remote place by a simulation apparatus connected to the actual apparatus via a network.

14. The method according to claim 11, wherein the simulation can be executed from a remote place by a simulation apparatus connected to the actual apparatus via a network, and is operated by multiple users between the simulation apparatus and the actual apparatus.

15. The method according to claim 11, wherein the actual apparatus includes an apparatus used in a semiconductor manufacturing process.

16. The method according to claim 11, further comprising the detection step of detecting a relative positional relationship with another object to be controlled on the basis of control procedure information of the object during control of the object by the control command.

17. The method according to claim 11, further comprising the detection step of detecting a relative positional relationship with another object to be controlled when operation stops during control of the object by the control command and a current position of the object becomes indefinite.

18. The method according to claim 17, wherein in the detection step, when a current position of the object is indefinite, an indefinite space where the object may exist is created from pre-stop position information and target position information of the object whose current position is indefinite and a control command to another object.

19. The method according to claim 18, further comprising the determination step of determining from the indefinite space created in the detection step whether the object interferes with another object to be controlled, and determining whether to continue operation of the actual apparatus.

20. The method according to claim 19, wherein, when no interference occurs as a determination result of the determination step, the simulation outputs a control continuation command for making the object to keep driving.

21. A program which executes simulation in synchronism with an actual apparatus, wherein the program causes a computer to realize functions of executing:
the simulation step of receiving a control command which concerns each object to be controlled and is output in controlling the actual apparatus, and executing simulation on the basis of the control command; and
the display step of receiving response information from the object with respect to the control command, and displaying a simulation result of the object based on the response information.

22. A computer-readable storage medium storing a program which executes simulation in synchronism with an actual apparatus, wherein the storage medium stores the program which causes a computer to realize functions of executing:
the simulation step of receiving a control command which concerns each object to be controlled and is output in controlling the actual apparatus, and executing simulation on the basis of the control command; and
the display step of receiving response information from the object with respect to the control command, and displaying a simulation result of the object based on the response information.
